(19) United States
(12) Patent Application Publication
(10) Pub. No.: US 2022/0137539 A1
(43) Pub. Date: May 5, 2022

(54) FIXING DEVICE AND IMAGE FORMING APPARATUS INCORPORATING SAME

(71) Applicant: Hiroki YAMAMURA, Tokyo (JP)

(72) Inventor: Hiroki YAMAMURA, Tokyo (JP)

(73) Assignee: Ricoh Company, Ltd.

(21) Appl. No.: 17/503,391

(22) Filed: Oct. 18, 2021

(30) Foreign Application Priority Data
Oct. 30, 2020 (JP) 2020-182311

(51) Int. Cl. G03G 15/20; G03G 15/00

(52) U.S. Cl. CPC G03G 15/2028; G03G 15/5029; G03G 15/2064

(57) ABSTRACT

An image forming apparatus includes a fixing device, a contact-separation mechanism and circuitry. The fixing device includes a fixing rotator to fix a toner image onto a sheet, a pressure rotator to press against the fixing rotator to form a nip, and a polisher to contact and polish a surface of the fixing rotator. The contact-separation mechanism contacts and separates the polisher to or from the fixing rotator. The circuitry calculates a cumulative weighted sheet passing distance that is a sum of values each obtained by multiplying a length of the sheet in a conveyance direction by a coefficient determined according to sheet information on the sheet different from the length every time the sheet passes through the nip and executes a control mode in which the contact-separation mechanism moves the polisher to contact the surface of the fixing rotator based on the cumulative weighted sheet passing distance.

### CROSS-REFERENCE TO RELATED APPLICATION

This patent application is based on and claims priority pursuant to 35 U.S.C. § 119 to Japanese Patent Application No. 2020-182311, filed on Oct. 30, 2020 in the Japan Patent Office, the entire disclosure of which is hereby incorporated by reference herein.

### BACKGROUND

### Technical Field

This disclosure generally relates to an image forming apparatus such as a copier, a facsimile machine, a printer, or a multifunction peripheral (MFP) having at least two of copying, printing, facsimile transmission, plotting, and scanning capabilities, and a fixing device used in the image forming apparatus.

### Related Art

One type of fixing device in an image forming apparatus such as a copier or a printer includes a polishing device that contacts and polishes a surface of a fixing rotator such as a fixing roller or a fixing belt at a predetermined timing in order to prevent a problem that the image quality of a fixed image deteriorates with time.

### SUMMARY

This specification describes an improved fixing device that includes a fixing device, a contact-separation mechanism and circuitry. The fixing device includes a fixing rotator configured to heat a toner image and fix the toner image onto a sheet, a pressure rotator configured to press against the fixing rotator to form a nip through which the sheet is conveyed, and a polisher configured to contact and polish a surface of the fixing rotator. The contact-separation mechanism is configured to move the polisher between a contact position at which the polisher contacts the fixing rotator and a separation position at which the polisher separates from the fixing rotator. The circuitry is configured to calculate a cumulative weighted sheet passing distance that is a sum of values each obtained by multiplying a length of the sheet passing through the nip in a conveyance direction by a coefficient determined according to sheet information on the sheet every time the sheet passes through the nip. The sheet information is different from the length of the sheet in the conveyance direction. The circuitry executes a control mode in which the contact-separation mechanism moves the polisher separated from the surface of the fixing rotator such that the polisher contacts the surface of the fixing rotator based on the cumulative weighted sheet passing distance.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view of a configuration of an image forming apparatus according to an embodiment of the present disclosure;

FIG. 2A is a brock diagram and a schematic view of a configuration of a fixing device according to the embodiment illustrated in FIG. 1;

FIG. 2B is a schematic view of the configuration of the fixing device of FIG. 2A when a polishing roller contacts a fixing belt;

FIG. 3 is a flowchart illustrating control performed in the fixing device;

FIG. 4 is a table illustrating a relationship between sheet thicknesses and weighting coefficients used to calculate cumulative weighted sheet passing distances, according to the embodiment illustrated in FIG. 1;

FIG. 5 is a table illustrating a relationship between basis weights and weighting coefficients used to calculate cumulative weighted sheet passing distances in a first variation of the embodiment;

FIG. 6 is a table illustrating a relationship between stiffness classifications of sheets and weighting coefficients used to calculate cumulative weighted sheet passing distances in a second variation of the embodiment;

FIG. 7 is a table illustrating a relationship between sheet types, basis weights, and weighting coefficients used to calculate cumulative weighted sheet passing distances in a third variation of the embodiment;

FIG. 8 is a table illustrating data for each brand of sheets stored in a memory according to a fourth variation; and

FIG. 9 is a flowchart illustrating control performed by the fixing device according to a fifth variation of the embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Referring now to the drawings, embodiments of the present disclosure are described below. As used herein, the singular forms “a,” “an,” and “the” are intended to include the plural forms as well, unless the context clearly indicates otherwise. Identical reference numerals are assigned to identical components or equivalents and a description of those components is simplified or omitted.

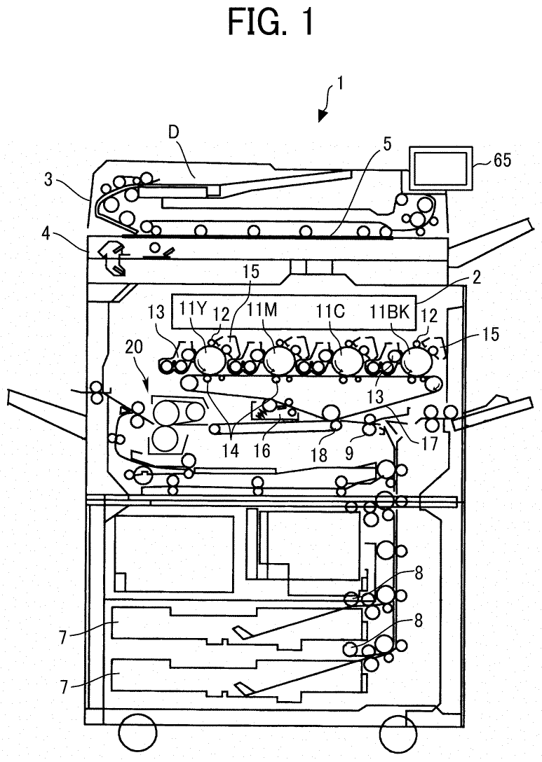

A description is provided of an image forming apparatus according to the present disclosure with reference to drawings. It is to be noted that the present disclosure is not to be considered limited to the following embodiments but can be changed within the range that can be conceived of by those skilled in the art, such as other embodiments, additions, modifications, deletions, and the scope of the present disclosure encompasses any aspect, as long as the aspect achieves the operation and advantageous effect of the present disclosure. Initially with reference to FIG. 1, a configuration and operation of an image forming apparatus 1 according to an embodiment of the present disclosure is described below.

In FIG. 1, the image forming apparatus 1, which is a multifunction peripheral (MFP) that includes functions of a copying machine and a printer, includes a writing device 2, a document conveyance device 3, a document reading device 4, a sheet feeding device 7. The writing device 2 emits a laser beam based on input image data. The document conveyance device 3 conveys an original document D to the document reading device 4. The document reading device 4 reads image data of the original document D. The sheet feeding device 7 contains sheets P such as paper sheets.

The image forming apparatus 1 further includes a registration roller pair 9 (also referred to as a timing roller pair), four photoconductor drums 11Y, 11M, 11C, and 11BK, and chargers 12. The registration roller pair 9 adjusts a conveyance timing of the sheet P. The photoconductor drums 11Y, 11M, 11C, and 11BK bear toner images of yellow, magenta, cyan, and black, respectively. The chargers charges the photoconductor drums 11Y, 11M, 11C, and 11BK, respectively.

The image forming apparatus 1 also includes developing devices 13, primary transfer bias rollers 14, and cleaners 15. The developing devices 13 develop electrostatic latent images formed on surfaces of the photoconductor drums 11Y, 11M, 11C, and 11BK into toner images of yellow, magenta, cyan, and black, respectively. The primary transfer bias rollers 14 transfer and superimpose the toner images formed on the surfaces of the photoconductor drums 11Y, 11M, 11C, and 11BK onto the intermediate transfer belt 17. Residual (untransferred) toner is collected from the surfaces of the photoconductor drums 11Y, 11M, 11C, and 11BK by the cleaners 15.

The image forming apparatus 1 further includes an intermediate transfer belt cleaner 16, the intermediate transfer belt 17, a secondary-transfer bias roller 18, and a fixing device 20. The intermediate transfer belt cleaner 16 cleans the intermediate transfer belt 17. The intermediate transfer belt 17 bears different colors of toner images superimposed one atop another. The secondary-transfer bias roller 18 transfers the toner images from the intermediate transfer belt 17 onto the sheet P as a composite color toner image. The fixing device 20 fixes the unfixed color toner image onto the sheet P.

The image forming apparatus 1 further includes an operation panel 65 that displays information relating to printing operations (image forming operations) and allows a user to perform operations relating to the printing operations.

The following describes color image forming operations (printing operations) of the image forming apparatus 1 to form a color toner image on a recording medium.

When a user uses the image forming apparatus 1 as the copier, the user places the original document D on a document table, inputs necessary information such as printing conditions to the operation panel 65 and presses a copy button.

Then, conveyance rollers of the document conveyance device 3 convey the original document D on the document table onto an exposure glass 5 of the document reading device 4. The document reading device 4 optically reads the image data of the original document D placed on the exposure glass 5.

Specifically, the document reading device 4 irradiates the image of the original document D on the exposure glass 5 with light emitted from a light source (e.g., a lamp), thereby scanning the image of the original document D. The light reflected on the original document D is imaged on a color sensor via mirrors and lenses. The multicolor image data of the original document D is read for each color separation light of red, green, and blue (RGB) by the color sensor and converted into electrical image signals. Further, the image signals are transmitted to an image processor that performs image processing (e.g., color conversion, color calibration, and spatial frequency adjustment) according to the color separation image signals of RGB, and thus image data of yellow, magenta, cyan, and black is obtained.

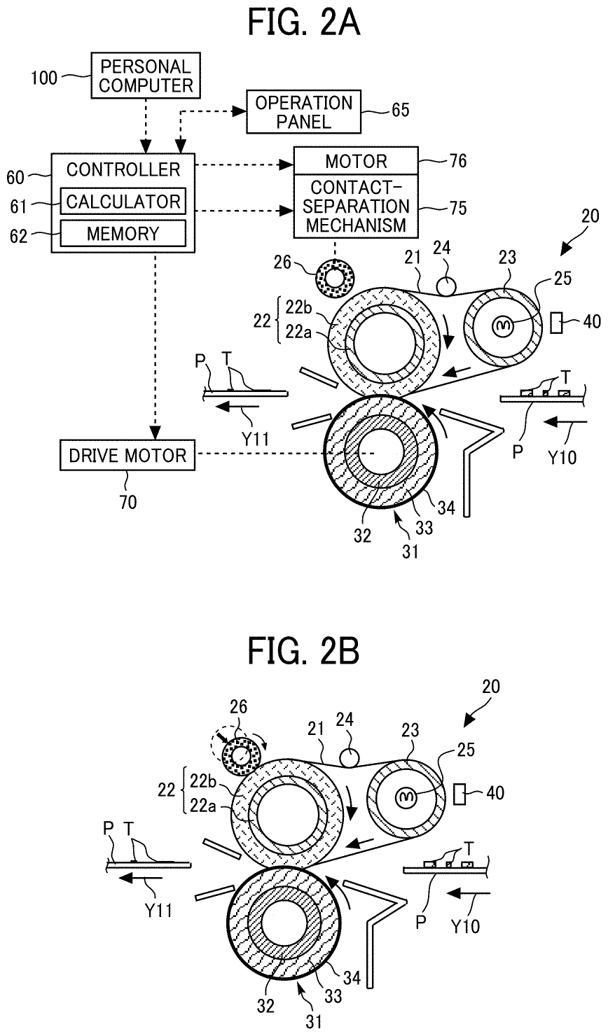

When the user uses the image forming apparatus 1 as the printer, the user inputs necessary information such as printing conditions and image data to an external input device such as a personal computer 100 (see FIG. 2A) coupled to be able to transmit to the image forming apparatus 1, and a controller 60 as circuitry including information acquisition circuitry of the image forming apparatus 1 acquires the necessary information.

The yellow, magenta, cyan, and black image data are transmitted to the writing device 2. The writing device 2 emits laser beams (e.g., exposure light) onto the surfaces of the photoconductor drums 11Y, 11M, 11C, and 11BK according to the image data of yellow, magenta, cyan, and black, respectively.

Each of the four photoconductor drums 11Y, 11M, 11C, and 11BK rotates counterclockwise in FIG. 1. The chargers 12 disposed opposite the photoconductor drums 11Y, 11M, 11C, and 11BK uniformly charge the outer circumferential surfaces of the photoconductor drums 11Y, 11M, 11C, and 11BK, respectively, which is referred to as a charging process. As a result, a charging potential is formed on the surface of each of the photoconductor drums 11Y, 11M, 11C, and 11BK. Subsequently, the charged surface of each of the photoconductor drums 11Y, 11M, 11C, and 11BK reaches a position to receive the laser beam L.

The writing device 2 emits the laser beam L corresponding to four colors from each of four light sources according to the image data. The respective laser beams L pass through different optical paths for components of yellow, magenta, cyan, and black. The above process is an exposure process.

For example, the surface of the leftmost photoconductor drum 11Y in FIG. 1 is irradiated with a laser beam corresponding to the image data of yellow. A polygon mirror that rotates at high velocity deflects the laser beam for yellow along the axis of rotation of the photoconductor drum 11Y (i.e., a main scanning direction and a width direction) so that the laser beam scans the surface of the photoconductor drum 11Y. Thus, an electrostatic latent image corresponding to the image data of yellow is formed on the photoconductor drum 11Y charged by the charger 12.

Similarly, the laser beam corresponding to the magenta component irradiates the outer circumferential surface of the second photoconductor drum 11M from the left in FIG. 1, forming an electrostatic latent image corresponding to the magenta component. The laser beam corresponding to the cyan component irradiates the outer circumferential surface of the third photoconductor drum 11C from the left in FIG. 1, forming an electrostatic latent image corresponding to the cyan component. The laser beam corresponding to the black component irradiates the outer circumferential surface of the fourth photoconductor drum 11BK from the left in FIG. 1, forming an electrostatic latent image corresponding to the black component.

Thereafter, the surface of each of the photoconductor drums 11Y, 11M, 11C, and 11BK bearing the electrostatic latent images reaches a developing position opposite each developing device 13. The developing devices 13 supply corresponding color toners to the photoconductor drums 11Y, 11M, 11C, and 11BK to develop the latent images on the photoconductor drums 11Y, 11M, 11C, and 11BK into single-color toner images, respectively. This is a development process.

After the development process, the surfaces of the photoconductor drums 11Y, 11M, 11C, and 11BK reach positions facing the intermediate transfer belt 17. The primary transfer bias rollers 14 are disposed at the positions at which the photoconductor drums 11Y, 11M, 11C, and 11BK face the intermediate transfer belt 17 and in contact with an inner surface of the intermediate transfer belt 17, respectively. At the positions of the primary transfer bias rollers 14, the toner images on the photoconductor drums 11Y, 11M, 11C, and 11BK are sequentially transferred to and superimposed on the intermediate transfer belt 17, forming a multicolor toner image thereon, in a primary transfer process.

After the primary transfer process, the surfaces of the photoconductor drums 11Y, 11M, 11C, and 11BK reach positions opposite the cleaners 15. The cleaners 15 remove and collect the residual (untransferred) toner from the outer circumferential surfaces of the photoconductor drums 11Y, 11M, 11C, and 11BK (a cleaning process).

Thereafter, a discharger discharges the outer circumferential surface of the respective photoconductor drums 11Y, 11M, 11C, and 11BK, finishing a series of image forming processes performed on the photoconductor drums 11Y, 11M, 11C, and 11K.

As described above, the multicolor toner image is formed on the intermediate transfer belt 17 by transferring and superimposing the respective single-color toner images formed on the photoconductor drums 11Y, 11M, 11C, and 11BK. Then, the intermediate transfer belt 17 bearing the multicolor toner image moves clockwise in FIG. 1 to reach a position opposite the secondary-transfer bias roller 18 (i.e., a secondary transfer nip). At the secondary transfer nip, the secondary-transfer bias roller 18 transfers the toner images of yellow, magenta, cyan, and black from the intermediate transfer belt 17 onto a sheet P as a multicolor toner image in a secondary transfer process.

Thereafter, the outer circumferential surface of the intermediate transfer belt 17 reaches a cleaning position opposite an intermediate transfer belt cleaner 16. The intermediate transfer belt cleaner 16 collects untransferred toner adhering to the intermediate transfer belt 17 to complete a series of transfer processes performed on the intermediate transfer belt 17.

The sheet P is conveyed from the sheet feeding device 7 via a registration roller pair 9 to the secondary transfer nip between the intermediate transfer belt 17 and the secondary-transfer bias roller 18. At the secondary transfer nip, the color toner image is formed on the sheet P thus conveyed.

In detail, a feed roller 8 feeds the sheet P from the sheet feeding device 7 that accommodates multiple sheets P, and the sheet P is conveyed to the registration roller pair 9 through a conveyance guide. The sheet P that has reached the registration roller pair 9 is conveyed toward the secondary transfer nip, timed to coincide with the arrival of the multicolor toner image on the intermediate transfer belt 17.

The multicolor toner image, in other words, a full-color image is transferred on the sheet P, and a conveyance belt conveys the sheet P to a fixing device 20. The fixing device 20 fixes the multicolor toner image onto a surface of the sheet P at a fixing nip between a fixing belt and a pressure roller in a fixing process.

After the fixing process, an output roller pair ejects the sheet P as an output image outside a main body of the image forming apparatus 1. Thus, a series of image forming processes ends.

Referring to FIG. 2A, the following describes a configuration and operation of the fixing device 20 incorporated in the image forming apparatus 1 described above.

As illustrated in FIG. 2A, the fixing device 20 includes a fixing belt 21 serving as a fixing rotator, a fixing assist roller 22, a heating roller 23, a tension roller 24, a heater 25 serving as a heat source, a temperature sensor 40, a pressure roller 31 serving as a pressure rotator, and a polishing roller 26 serving as a polisher and an abutment part.

The fixing belt 21 as the fixing rotator is a multi-layer endless belt constructed of a base layer made of resin such as polyimide, an elastic layer coating the base layer, and a release layer (a surface layer) coating the elastic layer. The elastic layer of the fixing belt 21 has a thickness of about 90 μm and is made of an elastic material such as silicone rubber, foamable silicone rubber, or fluoro rubber. The release layer of the fixing belt 21 has a thickness of about 20 μm and is made of, e.g., tetrafluoroethylene-perfluoroalkyl vinyl ether copolymer (PFA), polyimide, polyetherimide, or polyether sulfide (PES). The release layer as a surface layer of the fixing belt 21 facilitates separation of toner T contained in the toner image formed on the sheet P from the fixing belt 21. The fixing belt 21 is entrained around, and thus supported by two rollers, which are the fixing assist roller 22 and the heating roller 23. The fixing belt 21 travels in a direction indicated by arrow in FIGS. 2A and 2B. Using the fixing belt 21 having a low thermal capacity as the fixing rotator improves the temperature rise characteristic of the fixing device 20.

In addition, the fixing device 20 according to the present embodiment includes the tension roller 24 configured to press against the outer circumferential surface of the fixing belt 21 in order to apply a predetermined tension to the fixing belt 21 stretched and supported by the fixing assist roller 22 and the heating roller 23.

The fixing assist roller 22 includes a cored bar made of, for example, steel use stainless (SUS) such as SUS 304 that is defined by Japanese Industry Standard (JIS) and an elastic layer 22b formed on the cored bar and made of a foam material such as a silicone rubber foam. The fixing assist roller 22 is pressed against the pressure roller 31 as the pressure rotator via the fixing belt 21 to form the fixing nip. The elastic layer 22b made of a foam material enables setting a nip width (a nip amount) in the fixing nip to be relatively large and causes heat of the fixing belt 21 to be less likely to transfer to the fixing assist roller 22. The fixing assist roller 22 rotates clockwise in FIG. 2.

The heating roller 23 is a hollow roller made of metal such as aluminum or stainless steel, that is, a metal cylinder, and the heater 25 (that is, the heat source) as a heating component is fixed inside the cylinder. Setting the thickness of the heating roller 23 to be relatively thin reduces the thermal capacity of a heating body and improves the temperature characteristic of the fixing device (In other words, the rise time is shortened). The heater 25 as the heat source disposed in the heating roller 23 is a halogen heater, and both ends of the heater 25 are fixed to side plates of the fixing device 20. When the image forming apparatus 1 is powered on, a power supply supplies power to the heater 25. The controller 60 controls the power supplied to the heater 25. Radiant heat from the heater 25 heats the heating roller 23, and the heating roller 23 heats the fixing belt 21. The surface of the fixing belt 21 heated by the heating roller 23 applies heat to the toner image T on the sheet P.

The temperature sensor 40 is disposed opposite the outer circumferential surface of the fixing belt 21 without contacting the outer circumferential surface of the fixing belt 21. Based on a temperature detected by the temperature sensor 40, the controller 60 as the circuitry controls the power supplied to the heater 25. Specifically, the controller 60 determines a time for which the power supply applies an alternating current voltage to the heater 25 based on the temperature detected by the temperature sensor 40 (e.g., thermopile). The above-described control of the power supplied to the heater 25 adjusts the temperature of the fixing belt 21 (that is, a fixing temperature) to a desired temperature (that is, a target control temperature).

Although the fixing device 20 according to the present embodiment includes one heater 25 inside the heating roller 23, the fixing device 20 may include a plurality of heaters.

The pressure roller 31 (i.e., the pressure rotator) mainly includes a cored bar 32 made of metal, an elastic layer 33 resting an outer circumferential surface of the cored bar 32 via an adhesive layer, and a surface layer 34 (a release layer) resting an outer circumferential surface of the elastic layer 33. The elastic layer 33 of the pressure roller 31 has a layer thickness of about a few millimeters and is made of elastic material having insulation, such as silicone rubber foam, fluoro rubber, or silicone rubber. The surface layer 34 of the pressure roller 31 has a layer thickness of about several tens of micrometers to several hundreds of micrometers and is made of a low-friction material such as PFA (PFA tube) having conductivity. Providing the release layer having conductivity as the surface layer34 of the pressure roller 31 ensures the releasability (removability) with respect to the toner T of the toner image and prevents a disadvantage that the sheet P electrostatically stuck to the pressure roller 31 deteriorates separation of sheet P from the pressure roller 31.

In order to reduce the temperature difference between the fixing belt 21 and the pressure roller 31, the heater may be disposed inside the pressure roller 31.

A pressure device presses the pressure roller 31 against the fixing assist roller 22 via the fixing belt 21, thus forming a desired fixing nip between the pressure roller 31 and the fixing belt 21. The pressure device presses the pressure roller 31 against the fixing belt 21 (and the fixing assist roller 22) with a predetermined pressing force. The pressure device may be configured to be able to release (or reduce) the pressing force.

In the present embodiment, the elastic layer 33 of the pressure roller 31 has a smaller layer thickness and lower hardness than the elastic layer 22b of the fixing assist roller 22. As a result, the fixing assist roller 22 changes its form to have a concave portion along the roller shape of the pressure roller 31 at the nip between the pressure roller 31 and the fixing belt 21 (the fixing assist roller 22) as illustrated in FIGS. 2A and 2B. Therefore, the sheet P sent out from the nip easily draws a trajectory along the roller shape of the pressure roller 31.

In addition, the fixing device 20 according to the present embodiment includes the polishing roller 26 that comes into contact with the surface of the fixing belt 21 as the fixing rotator and polishes the surface of the fixing belt 21, which is described in detail below.

The fixing device 20 configured as described above operates as follows.

When the image forming apparatus 1 is powered on, the heater 25 is supplied with power. In other words, the AC voltage is applied to the heater 25.

In response to a print command or job command, a drive motor 70 drives and rotates the pressure roller 31 in a direction indicated by arrow in FIGS. 2A and 2B (counterclockwise). The rotation of the pressure roller 31 drives and rotates the fixing belt 21 (and the fixing assist roller 22 and the heating roller 23) in a direction indicated by arrow in FIGS. 2A and 2B (clockwise). Then, at the secondary transfer nip between the intermediate transfer belt 17 and the secondary-transfer bias roller 18, the toner image is transferred from the intermediate transfer belt 17 onto the sheet P fed from the sheet feeding device 7. Thus, the sheet P bears the toner image as an unfixed toner image T. As illustrated in FIGS. 2A and 2B, the sheet P bearing the unfixed toner image T is conveyed in a direction Y10 and enters the nip between the fixing belt 21 and the pressure roller 31 pressed against the fixing belt 21. The toner image T is fixed onto a surface of the sheet P under heat from the fixing belt 21 and pressure exerted from the fixing belt 21 (the fixing assist roller 22) and the pressure roller 31. Thereafter, the rotation of the fixing belt 21 and the pressure roller 31 ejects and conveys the sheet P from the nip in a direction indicated by arrow Y11.

The following describes a characteristic configuration and operation of the fixing device 20 (the image forming apparatus 1) according to the present embodiment in detail.

As described above with reference to FIG. 2A, the fixing device 20 includes the fixing belt 21 as the fixing rotator and the pressure roller 31 as the pressure rotator. The fixing belt 21 heats the toner image to fix the toner image onto the sheet P. The pressure roller 31 presses against the fixing belt 21 to form the nip (a fixing nip) through which the sheet P is conveyed.

Referring to FIGS. 2A and 2B, the fixing device 20 according to the present embodiment includes the polishing roller 26 as the polisher and the abutting member and a contact-separation mechanism 75. The polishing roller 26 abuts against the surface of the fixing belt 21 as the fixing rotator and polishes the surface thereof. The contact-separation mechanism 75 moves the polishing roller 26 such that the polisher roller 26 contacts the surface of the fixing belt 21 and is away from the surface of the fixing belt 21.

Many sheets passing through the fixing nip damages the surface of the fixing belt 21. The polishing roller 26 polishes the damaged surface of the fixing belt 21 to recovery (refresh) the surface of the fixing belt 21.

The polishing roller 26 is preferably configured to be able to contact at least the entire sheet passing area of the fixing belt 21. In the present embodiment, the polishing roller 26 contacts the entire area of the fixing belt 21 in the width direction (the direction perpendicular to the paper surface of FIG. 2).

Specifically, a motor 76 serving as a driver drives and rotates the polishing roller 26 serving as the abutting member.

The polishing roller 26 as the abutting member includes a cored bar and a binder layer formed on the cored bar. The binder layer is made of silicone rubber, fluororesin, or the like, and a large number of fine abrasive grains are dispersed in the binder layer. The abrasive grains may be white alumina, brown alumina crushed alumina, pink alumina, black silicon carbide, diamond, cubic boron nitride (CBN), or the like, having a particle size of about #1500. Preferably, the abrasive grains are selected so as not to cause a streaky abnormal image due to excessive roughening of the belt surface and so as not to cause a problem such as a decrease in glossiness of a fixed image. In addition, if the abrasive grains do not roughen the belt surface to some extent, removing matter attached to the surface of the fixing belt 21 from the surface and obtaining uniformity in local plastic deformation are difficult. Based on the above, the grain size of the abrasive grains is preferably selected from the range of #600 to #3000.

The polishing roller 26 of the present embodiment includes the binder layer in which a large number of fine abrasive grains are dispersed to obtain a predetermined surface roughness, but the surface of the polishing roller may be formed to have the predetermined surface roughness by sandblasting or the like.

The contact-separation mechanism 75 includes, for example, a cam mechanism. The controller 60 controls the contact-separation mechanism 75 to move the polishing roller 26 between a separation position and a contact position. At the separation position, the polishing roller 26 separates from the fixing belt 21 as illustrated in FIG. 2A. At the contact position, the polishing roller 26 is in contact with the fixing belt 21 as illustrated in FIG. 2B.

Typically, (for example, when the controller 60 does not execute a “recovery mode (control mode)” described below, such as during printing) the contact-separation mechanism 75 positions the polishing roller 26 at the separation position as illustrated in FIG. 2A. When the controller 60 executes the “recovery mode (control mode)”, the controller 60 controls the contact-separation mechanism 75 to move the polishing roller 26 to the contact position as illustrated in FIG. 2B.

In the present embodiment, a contact pressure of the polishing roller 26 contacting the fixing belt 21 is stable because the fixing belt 21 is sandwiched between the fixing assist roller 22 and the polishing roller 26 when the polishing roller 26 abuts on the fixing belt 21. As a result, the polishing roller 26 stably polishes the surface of the belt.

As illustrated in FIG. 2B, the motor 76 as the driver drives and rotates the polishing roller 26 in contact with the fixing belt 21 when the controller 60 executes the “recovery mode (control mode)” described below.

Rotating the polishing roller 26 as described above improves a polishing property of the polishing roller 26 polishing the belt surface and prevents the surface of the polishing roller 26 from being locally worn.

In the present embodiment, the motor 76 rotates the polishing roller 26 so as to be in sliding contact with the fixing belt 21 in a counter direction with respect to a rotation direction (a moving direction) of the fixing belt 21 at the contact position at which the polishing roller 26 contacts the fixing belt 21 in order to improve the polishing property of the polishing roller 26. Specifically, the motor 76 drives and rotates the polishing roller 26 clockwise in FIG. 2B.

The controller 60 according to the present embodiment calculates “a cumulative weighted sheet passing distance H” that is a sum (H=Σ(M×X)) of values (M×X) each obtained by multiplying a length M of the sheet P passing through the nip (the fixing nip) in a conveyance direction (in other words, M is referred to as a conveyance direction size) by a coefficient X (weighting coefficient) determined according to sheet information (in the present embodiment, the thickness of the sheet P) about the sheet P different from the length in the conveyance direction. The cumulative weighted sheet passing distance (H=Σ(M×X)) is cumulatively added every time the sheet P passes through the nip.

Based on the “cumulative weighted sheet passing distance H” obtained as described above, the controller 60 executes the “control mode” in which the contact-separation mechanism 75 moves the polishing roller 26 as the abutting member separated from the surface of the fixing belt 21 as the fixing rotator such that the polishing roller 26 contacts the surface of the fixing belt 21. In other words, the polishing roller 26 polishes the surface of the fixing belt 21 as described above with reference to FIG. 2B based on the “cumulative weighted sheet passing distance H”.

Hereinafter, such a control mode is referred to as the “recovery mode” as appropriate.

The controller 60 according to the present embodiment does not determine whether to execute the recovery mode based on a sum of the conveyance direction sizes M of the sheets P passing through the fixing nip (a cumulative sheet passing distance Σ(M)). The controller 60 determines whether to execute the recovery mode based on the cumulative weighted sheet passing distance H that is a total sum of values (M×X) obtained by weighting the conveyance direction sizes M of the sheets P passing through the fixing nip (obtained by multiplying the conveyance direction size M by the coefficient X).

This is because the damage to the surface of the fixing belt 21 due to the many sheets passing through the nip is not simply proportional to the total sum of the conveyance direction sizes M of the sheets P passing through the fixing nip, but is largely related to the characteristics of the sheet P other than the conveyance direction size.

In other words, simply determining whether to execute the recovery mode based on the total sum of the conveyance direction sizes of the sheets P passing through the nip may result in wastefully polishing the surface of the fixing belt 21 that is not so much damaged or not polishing the surface of the fixing belt 21 that is considerably damaged.

In contrast, the fixing device 20 in the present embodiment prevents the above-described disadvantage because the controller 60 determines whether to execute the recovery mode based on the cumulative weighted sheet passing distance H that is the total sum of weighted conveyance direction sizes M of the sheets P in order to reflect the progress state of the damage of the fixing belt 21. As a result, the fixing device 20 according to the present embodiment can efficiently prevent the disadvantage that the damage to the fixing belt 21 over time deteriorates image quality of the fixed image.

In particular, the controller 60 according to the present embodiment obtains the “cumulative weighted sheet passing distance” for each size of a plurality of different sizes of the sheets P passing through the nip (the fixing nip) in the width direction orthogonal to the conveyance direction. The size in the width direction is referred to as a “width direction size”.

The controller 60 executes the “recovery mode (control mode)” every time the “cumulative weighted sheet passing distance H” obtained for each size of the plurality of different sizes of the sheets P in the width direction exceeds the predetermined value A.

For example, the controller 60 executes the recovery mode when the “cumulative weighted sheet passing distance H” of the width direction size corresponding to A4 sheets set in a portrait direction reaches the predetermined value A even if the “cumulative weighted sheet passing distances H” of the other width direction sizes do not reach the predetermined value A. After that, the controller 60 executes the recovery mode when the “cumulative weighted sheet passing distance H” of the width direction size corresponding to A5 sheets set in a portrait direction reaches the predetermined value A even if the “cumulative weighted sheet passing distances H” of the other width direction sizes do not reach the predetermined value A.

The reason why the controller 60 executes the recovery mode as described above is that edges of both sides of the sheet P in the width direction cause most of the damage to the fixing belt 21.

Accordingly, executing the recovery mode every time the “cumulative weighted sheet passing distance H” obtained for each width direction size exceeds the predetermined value A can more efficiently prevent the disadvantage that the damage to the fixing belt 21 deteriorates the image quality of the fixed image over time. The predetermined value A is determined based on results of experiments in which the image forming apparatus 1 prints sheets for each of the sheet widths and the sheet types used in the image forming apparatus 1 to obtain data regarding when the damage to the fixing belt 21 deteriorates the image quality of the fixed image to a visible level. The predetermined value may be changed by operating the operation panel 65.

As described above, the coefficient X (weighting coefficient) in the present embodiment is determined according to the “thickness of the sheet P” as the sheet information.

The coefficient X of thick sheet is set to be larger than the coefficient X of thin sheet.

This is because as the thickness of the sheet P increases, the damage to the fixing belt 21 increases.

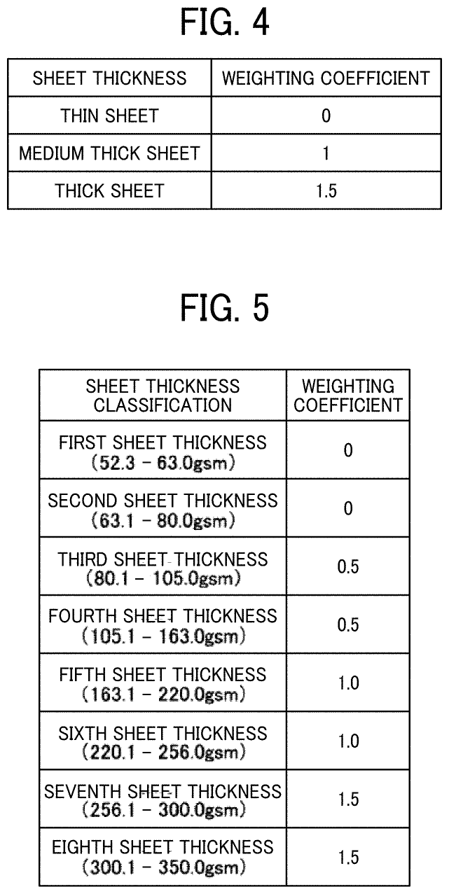

As a specific example, FIG. 4 illustrates a table listing the coefficients X as the weighting coefficients for the sheets P. In FIG. 4, the coefficient X (the weighting coefficient) for a thin sheet having a thin thickness (sheet thickness) is set to “0”, the coefficient X for a medium thick sheet having a medium thickness is set to “1”, and the coefficient X for a thick sheet having a thick thickness is set to “1.5”.

In the above-described case, assuming that the first sheet P is the thick sheet having a vertical size M1×a horizontal size N and the second to fifth sheets P are the medium thick sheets having a vertical size M2×the horizontal size N as the example, the “cumulative weighted sheet passing distances H” of the width direction size N is H=1×M1×1.5+4×M2×1.

Note that the specific example of FIG. 4 is just an example. It is preferable to set the optimum coefficient X based on the relationship with the damage of the fixing belt 21. This also applies to specific examples illustrated in FIGS. 5 to 8 described below.

In the “recovery mode (control mode)” according to the present embodiment, the motor 76 as the driver rotates the polishing roller 26 as the abutting member in contact with the surface of the rotating fixing belt 21 as the fixing rotator. That is, when the controller 60 executes the recovery mode, the polishing roller 26 that has stopped rotating at the separation position as illustrated in FIG. 2A moves to the contact position and rotates at the contact position as illustrated in FIG. 2B.

In the present embodiment, the controller 60 executes the “recovery mode (control mode)” after a series of printing operations (that is, a print job) is completed.

Specifically, after the series of printing operations (the print job) is completed, the controller 60 calculates the “cumulative weighted sheet passing distance H” and executes the recovery mode in response to the value H exceeding the predetermined value A.

The above-described control can prevent a disadvantage that the print job is interrupted, and downtime occurs.

The image forming apparatus 1 according to the present embodiment includes information acquisition circuitry that acquires information on the length of the sheet P in the conveyance direction (that is, the conveyance direction size) and the sheet information (in the present embodiment, the thickness of the sheet P). Specifically, the operation panel 65 illustrated in FIG. 2A functions as the information acquisition circuitry when the image forming apparatus 1 is used as the copier. The user inputs various information on the sheet P through the operation panel 65. When the image forming apparatus 1 is used as the printer, the user operates the external input device such as the personal computer 100 to communicate the controller 60 in the image forming apparatus 1 and send various information on the sheet P from the personal computer 100. Therefore, the controller 60 functions as the information acquisition circuitry.

As described above, the image forming apparatus 1 in the present embodiment includes the information acquisition circuitry that acquires the conveyance direction size and the thickness (the sheet information) of the sheet P based on data input by the operation panel 65 or the personal computer 100 and does not include a detector that directly detects the conveyance direction size and the thickness of the sheet. Therefore, the production cost and the size of the image forming apparatus 1 in the present embodiment is smaller than those of the image forming apparatus including the detector.

The controller 60 in the image forming apparatus 1 includes a memory 62 that stores the cumulative weighted sheet passing distance H and the coefficients X (that is the table including the coefficients as illustrated in FIG. 4) determined according to the sheet information.

In addition, the controller 60 in the image forming apparatus 1 includes a calculator 61 that calculates the cumulative weighted sheet passing distance H based on the coefficients X stored in the memory 62, the sheet information (information on the thickness of the sheet P) acquired by the information acquisition circuitry, and the information on the length of the sheet P in the conveyance direction (that is the conveyance direction size) acquired by the information acquisition circuitry.

When the controller 60 does not execute the recovery mode (control mode), the controller 60 updates the cumulative weighted sheet passing distance H stored in the memory 62 to the cumulative weighted sheet passing distance H calculated by the calculator 61. In other words, the controller 60 rewrites the data in the memory 62 so as to update the cumulative weighted sheet passing distance H′ previously calculated to the cumulative weighted sheet passing distance H obtained by adding the new weighted sheet passing distance M×X to the cumulative weighted sheet passing distance H′ previously calculated when the controller 60 does not execute the recovery mode.

On the contrary, when the controller 60 executes the recovery mode (control mode), the controller 60 resets the cumulative weighted sheet passing distance H stored in the memory 62 (to 0).

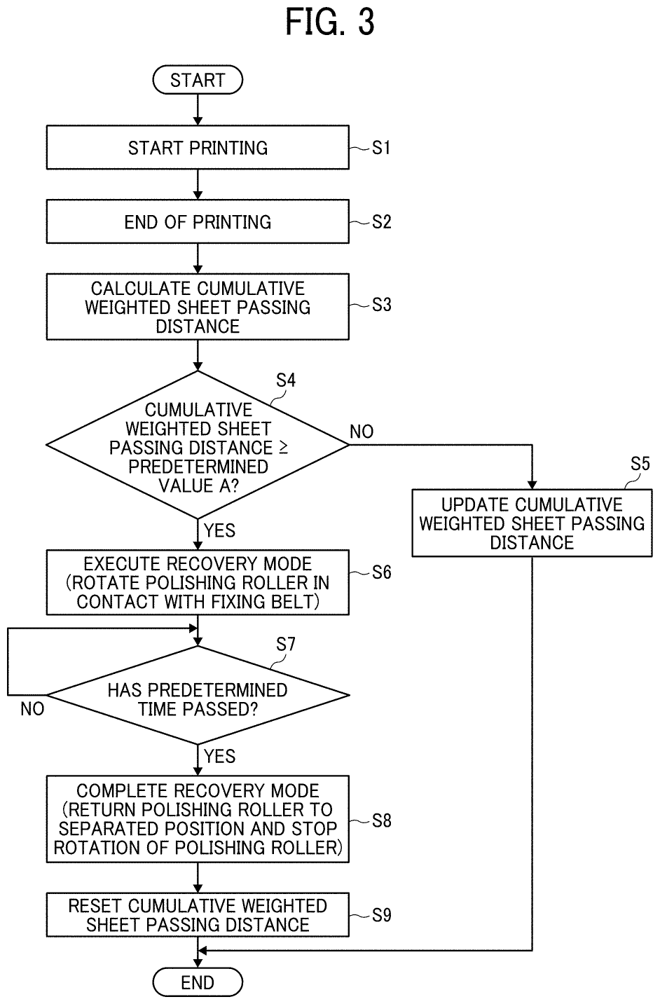

With reference to FIG. 3, the following describes a control flow regarding the recovery mode described above.

After the printing (the print job) starts and ends in steps S1 and S2, the calculator 61 calculates the cumulative weighted sheet passing distance H in step S3.

Subsequently, the controller 60 determines whether or not the cumulative weighted sheet passing distance H calculated in step S3 is equal to or greater than the predetermined value A in step S4. When the controller 60 determines that the cumulative weighted sheet passing distance H is not equal to or greater than the predetermined value A, the damage to the fixing belt 21 does not cause deterioration of the image quality of the fixed image, and the controller 60 does not execute the recovery mode. Then, in step S5, the controller 60 updates the cumulative weighted sheet passing distance H that has stored in the memory 62 to the cumulative weighted sheet passing distance calculated in step S3, and the control flow is ended.

In contrast, when the controller 60 determines that the cumulative weighted sheet passing distance H is equal to or greater than the predetermined value A in step S4, the damage to the fixing belt 21 may cause the deterioration of the image quality of the fixed image, and the controller 60 starts execution of the recovery mode in step S6. Specifically, the polishing roller 26 is rotationally driven in contact with the fixing belt 21.

After a predetermined time has passed (YES in step S7), the controller 60 completes the recovery mode in step S8. Specifically, the contact-separation mechanism 75 returns the polishing roller 26 to the separation position, and the motor 76 stops rotating the polishing roller 26.

Then, the controller 60 resets the cumulative weighted sheet passing distances H stored in the memory 62 in step S9, and the control flow is ended.

Next, a first variation is described.

In the first variation, the sheet information is the basis weight of the sheet P, and the coefficient X (weighting coefficient) is determined according to the basis weight of the sheet P.

The coefficient X of the sheet P having a large basis weight is set to be larger than the coefficient X of the sheet P having a small basis weight.

This is because the basis weight of the sheet P correlates with the thickness of the sheet P, and as the basis weight of the sheet P increases, the damage to the fixing belt 21 increases.

As a specific example, FIG. 5 illustrates a table listing the coefficients X as the weighting coefficients for the sheets P and sheet thickness classifications classified by the basis weights of the sheets P. As illustrated in FIG. 5, the sheet P having the basis weight from 52.3 grams per square meters (gsm) to 63.0 gsm is classified to as a first sheet thickness and the coefficient X (the weighting coefficient) is set to “0”. The sheet P having the basis weight from 63.1 gsm to 80.0 gsm is classified to as a second sheet thickness and the coefficient X (the weighting coefficient) is set to “0”. The sheet P having the basis weight from 80.1 gsm to 105.0 gsm is classified to as a third sheet thickness and the coefficient X (the weighting coefficient) is set to “0.5”. The sheet P having the basis weight from 105.1 gsm to 163.0 gsm is classified to as a fourth sheet thickness and the coefficient X (the weighting coefficient) is set to “0.5”. The sheet P having the basis weight from 105.1 gsm to 220.0 gsm is classified to as a fifth sheet thickness and the coefficient X (the weighting coefficient) is set to “1.0”. The sheet P having the basis weight from 220.1 gsm to 256.0 gsm is classified to as a sixth sheet thickness and the coefficient X (the weighting coefficient) is set to “1.0”. The sheet P having the basis weight from 256.1 gsm to 300.0 gsm is classified to as a seventh sheet thickness and the coefficient X (the weighting coefficient) is set to “1.5”. The sheet P having the basis weight from 300.1 gsm to 350.0 gsm is classified to as an eighth sheet thickness and the coefficient X (the weighting coefficient) is set to “1.5”.

As a result, the fixing device 20 according to the first variation can also efficiently prevent the disadvantage that the damage to the fixing belt 21 over time deteriorates image quality of the fixed image.

Next, a second variation is described.

In the second variation, the sheet information is the stiffness (rigidity) of the sheet P, and the coefficient X (weighting coefficient) is determined according to the stiffness of the sheet P.

The coefficient X of the sheet P having a high stiffness is set to be larger than the coefficient X of the sheet P having a low stiffness.

This is because as the stiffness of the sheet P increases, the damage to the fixing belt 21 increases.

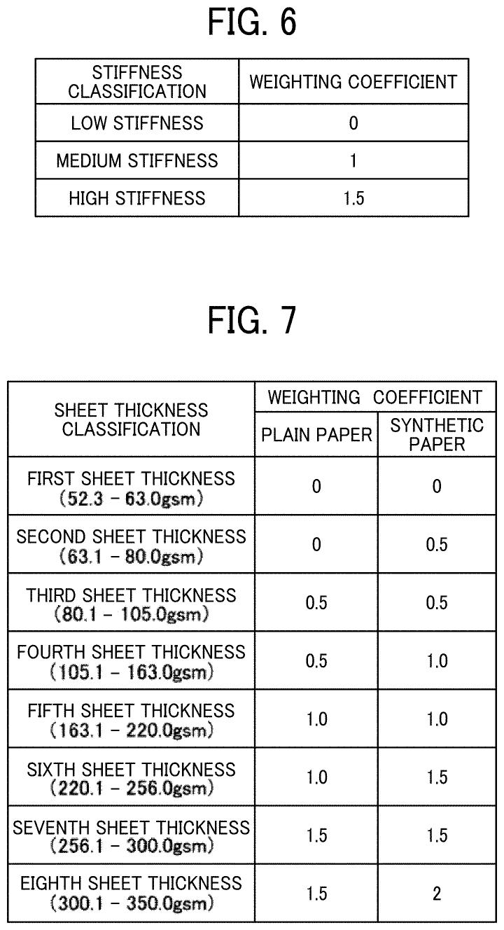

As a specific example, FIG. 6 illustrates a table listing the coefficients X as the weighting coefficients for the sheets P having different stiffness. In FIG. 6, the coefficient X (the weighting coefficient) for the sheet P having the low stiffness is set to “0”, the coefficient X for the sheet P having a medium stiffness is set to “1”, and the coefficient X for the sheet P having the high stiffness is set to “1.5”.

As a result, the fixing device 20 according to the second variation can also efficiently prevent the disadvantage that the damage to the fixing belt 21 over time deteriorates image quality of the fixed image.

Next, a third variation is described.

In the third variation, the sheet information is a type of the sheet P, and the coefficient X (weighting coefficient) is determined according to the type of the sheet P.

This is because the fixing belt 21 is damaged differently depending on the type of the sheet P.

As a specific example, FIG. 7 illustrates a table listing the coefficients X set by the types of sheets P (depending on whether the sheet P is plain paper or synthetic paper) in addition to the basis weights of the sheets P. The coefficients of the synthetic paper are set to be larger than the coefficients of the plain paper because the damage to the fixing belt 21 when a sheet of the synthetic paper passes through the fixing nip is severer than the damage to the fixing belt 21 when a sheet of the plain paper passes through the fixing nip even if the sheet of the synthetic paper and the sheet of the plain paper have the same basis weight (that is, the same thickness).

As a result, the fixing device 20 according to the third variation can also efficiently prevent the disadvantage that the damage to the fixing belt 21 over time deteriorates image quality of the fixed image.

In the third variation, the sheets P are classified into two types, that is, plain paper and synthetic paper for the sake of simplicity, but the sheets P may be classified into three or more types. For example, the synthetic paper may be further classified into synthetic pulp paper, synthetic film paper, and synthetic plastic paper, and the weighting coefficient X may be set to each of the three paper. In addition, the weighting coefficient X may be set for coated paper. In this case, the coated paper may be further classified into gross coated paper and matt coated paper, and the weighting coefficient X may be set to each of the two paper.

Next, a fourth variation is described.

In the fourth variation, the sheet information is a brand of the sheet P, and the coefficient X (weighting coefficient) is determined according to the brand of the sheet P.

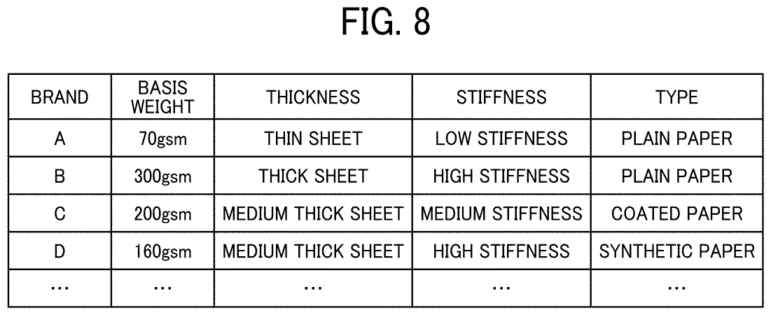

This is because, as illustrated in FIG. 8, the brand of the sheet P precisely identifies the basis weight, the thickness, the stiffness, and the type of the sheet P that are relate to the damage to the fixing belt 21. Specifically, in the fourth variation, the controller 60 refers to a table illustrating a relationship between the coefficients X and the brands of sheets P stored in the memory 62 in advance and determines the coefficient X (weighting coefficient) corresponding to the brand of the sheet P passing through the fixing nip based on the brand of the sheet P input to the operation panel 65 or the personal computer 100. When the brand of the sheet P input to the operation panel 65 or the personal computer 100, data regarding the conveyance direction size M of the sheet P may be input at the same time. At this time that is before the start of printing, the calculator may calculate the cumulative weighted sheet passing distance H. That is, the controller 60 may execute the recovery mode (control mode) before the start of the series of printing operations.

As a result, the fixing device 20 according to the fourth variation can also efficiently prevent the disadvantage that the damage to the fixing belt 21 over time deteriorates image quality of the fixed image.

Next, a fifth variation is described.

In the fifth variation, the controller 60 executes the recovery mode (control mode) before the start of the series of printing operations (the print job).

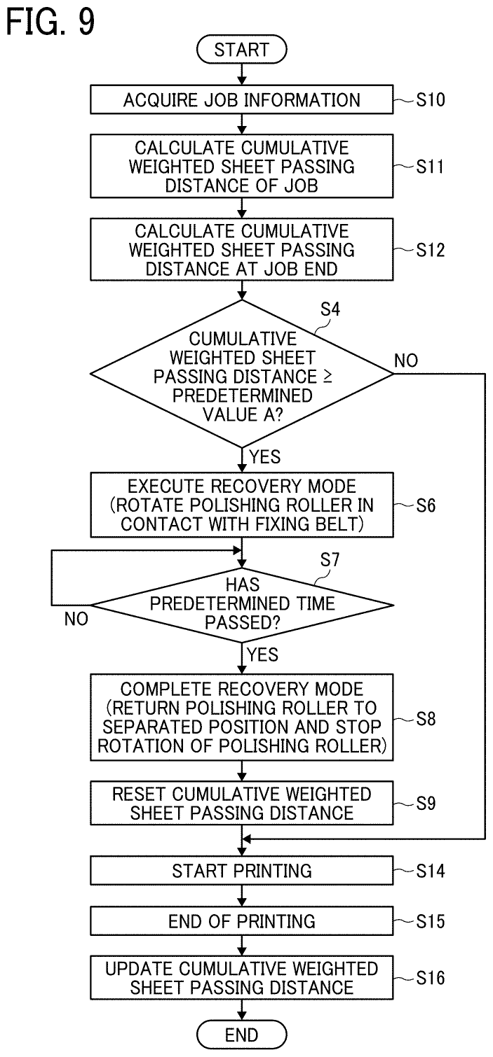

FIG. 9 illustrates a flow chart regarding the fifth variation. Firstly, the user operates and inputs information on printing (the print job), which is, in particular, the conveyance direction size of the sheet and the sheet information, to the operation panel 65 or the personal computer 100. The operation panel 65 or the controller 60 acquires the information in step S10.

Based on the information acquired in step S10, the calculator 61 calculates the cumulative weighted sheet passing distance H of the print job in step S11. Subsequently, the calculator 61 calculates in advance the cumulative weighted sheet passing distance H at the end of the print job that is sum of the cumulative weighted sheet passing distance H calculated in step Sll and the cumulative weighted sheet passing distance H stored in the memory at the end of the previous print job in step S12.

Then, the controller 60 determines whether or not the cumulative weighted sheet passing distance H calculated in step S12 is equal to or larger than a predetermined value A in step S4. When the controller 60 determines that the cumulative weighted sheet passing distance H is not equal to or larger than the predetermined value A, the damage to the fixing belt 21 does not cause the deterioration of the image quality of the fixed image, and the controller 60 starts the printing (the print job) in step S14 without executing the recovery mode. When the printing is completed in step S15, the controller 60 updates the cumulative weighted sheet passing distances H stored in the memory 62 to the cumulative weighted sheet passing distance H calculated in step S12 in step S16, and the present flow is finished.

In contrast, when the controller 60 determines that the cumulative weighted sheet passing distance H is equal to or larger than the predetermined value A in step S4, the damage to the fixing belt 21 may cause the deterioration of the image quality of the fixed image, and the controller 60 starts execution of the recovery mode in step S6. In step S7, the controller determines whether a predetermined time has passed. After the predetermined time has passed (YES in step S7), the controller 60 completes the recovery mode in step S8 and resets the cumulative weighted sheet passing distances H stored in the memory in step S9. Thereafter, the printing (the print job) is started in step S14 and ended in step S15. In step S16, the controller 60 updates the cumulative weighted sheet passing distances H stored in the memory 62 to the cumulative weighted sheet passing distance H reset in step S9, and the present flow is finished.

As a result, the fixing device 20 according to the fifth variation can also efficiently prevent the disadvantage that the damage to the fixing belt 21 over time deteriorates image quality of the fixed image.

As described above, the fixing device 20 according to the present embodiment includes the fixing belt 21 as the fixing rotator configured to heat and fix the toner image on the sheet P, the pressure roller 31 as the pressure rotator configured to press against the fixing belt 21 to form the nip that coveys the sheet P, the polishing roller 26 as the abutting member configured to contact and polish the surface of the fixing belt 21, and the contact-separation mechanism 75 configured to contact or separate the polishing roller 26 to or from the surface of the fixing belt 21. The calculator 61 in the controller 60 calculates the cumulative weighted sheet passing distance that is the sum of values each obtained by multiplying the length of the sheet P passing through the nip in the conveyance direction by the coefficient determined according to the sheet information on the sheet P (that is the sheet information different from the length in the conveyance direction), and the sum of values is cumulatively added every time the sheet P passes through the nip. Based on the cumulative weighted sheet passing distance, the controller 60 executes the “recovery mode (the control mode)” in which the contact-separation mechanism 75 moves the polishing roller 26 separated from the surface of the fixing belt 21 such that the polisher contacts the surface of the fixing belt 21.

As a result, the fixing device can efficiently prevent deterioration of the image quality of the fixed image over time.

Although the fixing rotator in the present embodiment is the fixing belt 21 (that is, the belt), the fixing rotator may be a fixing roller (that is, a roller).

Although the pressure rotator in the present embodiment is the pressure roller 31 (that is, the roller), the pressure rotator may be a pressing belt (that is, a belt).

In the present embodiment, the present disclosure is applied to the fixing device 20 of the heat heater type using the heater 25 as the heat source, but the application of the present disclosure is not limited to this. For example, the present disclosure may be applied to the fixing device employing an electromagnetic induction system or an induction heating (111) system using an electromagnetic induction coil as the heat source or the fixing device of a resistance heating type using a resistive heat generator as the heat source.

Such cases also provide substantially the same effects as the effects described above.

Numerous additional modifications and variations are possible in light of the above teachings. It is therefore to be understood that within the scope of the present disclosure, the present disclosure may be practiced otherwise than as specifically described herein. The number, position, and shape of the components described above are not limited to those embodiments described above. Desirable number, position, and shape can be determined to perform the present disclosure.

It is to be noted that the sheet P in this specification is not limited to indicate a paper but also defined as a sheet-like recording medium including any other sheet-like recording medium such as a coated paper sheet, a label paper, and an overhead projector (OHP) transparencies.

The above-described embodiments are illustrative and do not limit this disclosure. Thus, numerous additional modifications and variations are possible in light of the above teachings. For example, elements and/or features of different illustrative embodiments may be combined with each other and/or substituted for each other within the scope of this disclosure. Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

The effects obtained by the above-described embodiment and variations are examples. The effects according to the present disclosure are not limited to the above-described effects.

What is claimed is:

1. An image forming apparatus comprising:
a fixing device including:
a fixing rotator configured to heat a toner image and fix the toner image onto a sheet;
a pressure rotator configured to press against the fixing rotator to form a nip through which the sheet is conveyed; and
a polisher configured to contact and polish a surface of the fixing rotator;
a contact-separation mechanism configured to move the polisher between a contact position at which the polisher contacts the fixing rotator and a separation position at which the polisher separates from the fixing rotator; and
circuitry configured to:
calculate a cumulative weighted sheet passing distance that is a sum of values each obtained by multiplying a length of the sheet passing through the nip in a conveyance direction by a coefficient determined according to sheet information on the sheet every time the sheet passes through the nip, the sheet information being different from the length in the conveyance direction; and
execute a control mode in which the contact-separation mechanism moves the polisher separated from the surface of the fixing rotator such that the polisher contacts the surface of the fixing rotator based on the cumulative weighted sheet passing distance. 2. The image forming apparatus according to claim 1,
wherein the circuitry is configured to:
calculate the cumulative weighted sheet passing distance for each size of a plurality of different sizes of sheets in a width direction of each of the sheets passing through the nip; and
execute the control mode every time the cumulative weighted sheet passing distance calculated for each size of the plurality of different sizes of sheets in the width direction exceeds a predetermined value.

3. The image forming apparatus according to claim 1,
wherein the sheet information includes a thickness of the sheet, and
wherein as the thickness of the sheet is larger, the coefficient is larger.

4. The image forming apparatus according to claim 1,
wherein the sheet information includes a basis weight of the sheet, and
wherein as the basis weight of the sheet is larger, the coefficient is larger.

5. The image forming apparatus according to claim 1,
wherein the sheet information includes a stiffness of the sheet, and
wherein as the stiffness of the sheet is higher, the coefficient is larger.

6. The image forming apparatus according to claim 1,
wherein the sheet information includes a type of the sheet.

7. The image forming apparatus according to claim 1,
wherein the sheet information includes a brand of the sheet.

8. The image forming apparatus according to claim 1, further comprising
a motor configured to rotate the polisher,
wherein the circuitry is configured to control the motor to rotate the polisher contacting the surface of the fixing rotator rotating in the control mode.

9. The image forming apparatus according to claim 1,
wherein the circuitry is configured to execute the control mode after a series of printing operations is completed.

10. The image forming apparatus according to claim 1,
wherein the circuitry is configured to execute the control mode before a start of a series of printing operations.

11. The image forming apparatus according to claim 1,
wherein the circuitry includes:
information acquisition circuitry configured to acquire information on the length of the sheet in the conveyance direction and the sheet information;
a memory configured to store the cumulative weighted sheet passing distance and the coefficient determined according to the sheet information; and
a calculator configured to calculate the cumulative weighted sheet passing distance based on the coefficient stored in the memory, the sheet information acquired by the information acquisition circuitry, and the information on the length of the sheet in the conveyance direction acquired by the information acquisition circuitry, and
wherein the circuitry is configured to:
update the cumulative weighted sheet passing distance stored in the memory to the cumulative weighted sheet passing distance calculated by the calculator when the circuitry does not execute the control mode; and
reset the cumulative weighted sheet passing distance stored in the memory when the circuitry executes the control mode.
